(19) United States
(12) Patent Application Publication
(10) Pub. No.: US 2013/0290218 A1
(43) Pub. Date: Oct. 31, 2013

(54) SYSTEM AND METHOD FOR REGULATORY COMPLIANCE MANAGEMENT

(71) Applicant: ASCENDANT COMPLIANCE MANAGEMENT, Salisbury, CT (US)

(72) Inventors: Jacqueline MERWIN, Falls Village, CT (US); Jon HIGGINS, Taconic, CT (US); Christopher HARDY, Salisbury, CT (US); Keith MARKS, Lakeville, CT (US)

(73) Assignee: ASCENDANT COMPLIANCE MANAGEMENT, Salisbury, CT (US)

(21) Appl. No.: 13/840,191

(22) Filed: Mar. 15, 2013

Related U.S. Application Data
(60) Provisional application No. 61/640,500, filed on Apr. 30, 2012.

(51) Int. Cl. G06Q 40/06

(52) U.S. Cl. CPC G06Q 40/06
USPC 705/36 R

(57) ABSTRACT

A regulatory compliance management system, method, and program for regulatory compliance management are provided. A method for regulatory compliance management includes: based on an investment portfolio, tagging and searching, by a query module, regulatory and other documents; receiving, by an analysis module, the documents; based on the received documents: determining and displaying trade errors; summarizing and displaying transactions in different accounts in the investment portfolio; summarizing and displaying instances of long and short positions occurring within a same security in the investment portfolio; determining and displaying daily trading volume for a security in the investment portfolio; determining and displaying total price times quantity of transactions for specific broker dealers in the investment portfolio; determining and displaying commissions in the investment portfolio; determining and displaying population standard deviation and distance from the mean for transactions within accounts, brokerages, and securities in the investment portfolio over a selectable time period.

### CROSS-REFERENCE TO RELATED APPLICATION(S)

This application claims the benefit of U.S. Provisional Patent Application No. 61/640,500, filed on Apr. 30, 2012, the entire disclosure of which is incorporated herein by reference for all purposes.

### BACKGROUND

1. Field

The following disclosure relates to a system and method for regulatory compliance management, more particularly, to computing devices, including but not limited to, computing devices and methods for trade blotter analysis and risk analysis.

2. Background

The Securities and Exchange Commission (SEC) has stated that trade blotter analysis is an important part of a registered investment adviser's compliance program. A “trade blotter” is a list of all securities transactions that have occurred at an investment adviser or broker dealer for accounts under portfolio management during a given period of time. “Investment Adviser” is a broad term that includes investment managers of various types, traditional investment managers, hedge and private fund managers. At the end of 2010, the SEC stated that there were 11,888 registered investment advisers, with this number expected to rise because of the influx of Private Funds, which would be required to register as a result of stipulations related to the Dodd-Frank legislation. The SEC has further stated that it examines roughly 10% of this pool of advisers on an annual basis. Thus, trade blotter analysis is a critical component of the adviser or broker dealer's compliance program. The SEC requires a report (“Form ADV”) to be filed by investment advisers. The Form ADV is for reporting information about an investment adviser, e.g., education, business, regulatory problems, services, and fees.

In the past few years, the SEC has emphasized Enterprise Risk Management and the necessity for investment advisers to assess risk internally through governance structures and the creation of a risk matrix document. The SEC has also indicated that the examination process, which has long been based upon rotation, will be conducted based upon the SEC's determination of risk factors measured by specific criteria including disclosure documents. The SEC's formal term for these examinations is “risk based.”

Therefore, Chief Compliance Officers (CCOs) and compliance personnel of registered investment advisers are compelled to perform their own analysis of their trade blotter or record of transactions. This is a tedious process that involves the manual sorting and grouping of specific transactions to search for errors, aberrations, and/or patterns that reveal activities in specific accounts. The SEC requests trade blotter information be provided in Microsoft Excel® format, with specific columns of information as part of its document request for routine examinations. Moreover, advisers are required to provide their trade data in Microsoft Excel® to the SEC as part of routine examinations. However, many CCOs and compliance personnel are not experts or adept in the use of Microsoft Excel®, and do not understand how to manipulate the Microsoft Excel® data to perform their own analysis. Furthermore, most trade advisers do not understand which criteria to examine.

Also, Chief Compliance Officers (CCOs) and compliance personnel of registered investment advisers should analyze within their companies and with coordination of other adviser firm personnel the enterprise risk, including the compliance risk, of such investment adviser. Performing a risk management framework and work flow processing plan is an enormous task for CCOs at registered investment advisers based on their regulatory requirements. This is a process that requires informed judgment and the necessary information for such judgment or risk ranking.

Accordingly, there is a need and desire for a system and method for regulatory compliance management.

### SUMMARY

Embodiments of the present invention relate to a system and method for regulatory compliance management.

Embodiments may provide queries and studies that may help a registered investment adviser identify potential errors, aberrations, and patterns, and address such issues, thus improving and strengthening their trading and risk management processes. Most importantly, CCOs and compliance personnel may be able, more efficiently and in depth, to practice their own trade blotter analysis, document the process, and, in doing so, may demonstrate a thorough and effective compliance process, or unfair practices by advisory personnel. Embodiments may provide understanding and improvement of the compliance process and pre-empt the discovery of deficiencies by the SEC. Embodiments may simplify and/or automate the conventional trade blotter analysis process and risk management based on regulatory documents.

Additional advantages, objects, and features of the disclosure may be set forth in part in the description which follows and in part may become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the embodiments, as embodied and broadly described herein, there is provided a regulatory compliance management system, comprising a user data entry device; a display device; a processor comprising logic to process data; a database in communication with the processor, the database comprising regulatory and other documents; a query module in communication with the processor and the database, the query module configured to tag and search the documents based on an investment portfolio; an analysis module in communication with the processor and the query module, the analysis module configured to receive the documents from the query module and, based on the received documents: determine and display, on the display device, trade errors; summarize and display, on the display device, transactions in different accounts in the investment portfolio; summarize and display, on the display device, instances of long and short positions occurring within a same security in the investment portfolio; determine and display, on the display device, daily trading volume for a security in the investment portfolio; determine and display, on the display device, total price times quantity of transactions for specific broker dealers in the investment portfolio; determine and display, on the display device, commissions in the investment portfolio; determine and display, on the display device, population standard deviation and distance from the mean for transactions within accounts in the investment portfolio over a selectable time period; determine and display, on the display device, population standard deviation and distance from the mean for brokerages in the investment portfolio over a selectable time period; and determine and display, on the display device, population standard deviation and distance from the mean for securities in the investment portfolio over a selectable time period.

In another aspect, there is provided a method for regulatory compliance management, the method comprising, based on an investment portfolio, tagging and searching, by a query module, regulatory and other documents, the query module being in communication with a processor and a database comprising the documents; receiving, by an analysis module in communication with the processor and the query module, the documents from the query module; based on the received documents: determining and displaying, on a display device, trade errors; summarizing and displaying, on the display device, transactions in different accounts in the investment portfolio; summarizing and displaying, on the display device, instances of long and short positions occurring within a same security in the investment portfolio; determining and displaying, on the display device, daily trading volume for a security in the investment portfolio; determining and displaying, on the display device, total price times quantity of transactions for specific broker dealers in the investment portfolio; determining and displaying, on the display device, commissions in the investment portfolio; determining and displaying, on the display device, population standard deviation and distance from the mean for transactions within accounts in the investment portfolio over a selectable time period; determining and displaying, on the display device, population standard deviation and distance from the mean for brokerages in the investment portfolio over a selectable time period; and determining and displaying, on the display device, population standard deviation and distance from the mean for securities in the investment portfolio over a selectable time period.

In another aspect, there is provided a non-transitory computer readable medium including a program and a computer executable program code for a computer-implemented method for regulatory compliance management, comprising, based on an investment portfolio, tagging and searching, by a query module, regulatory and other documents, the query module being in communication with a processor and a database comprising the documents; receiving, by an analysis module in communication with the processor and the query module, the documents from the query module; based on the received documents: determining and displaying, on a display device, trade errors; summarizing and displaying, on the display device, transactions in different accounts in the investment portfolio; summarizing and displaying, on the display device, instances of long and short positions occurring within a same security in the investment portfolio; determining and displaying, on the display device, daily trading volume for a security in the investment portfolio; determining and displaying, on the display device, total price times quantity of transactions for specific broker dealers in the investment portfolio; determining and displaying, on the display device, commissions in the investment portfolio; determining and displaying, on the display device, population standard deviation and distance from the mean for transactions within accounts in the investment portfolio over a selectable time period; determining and displaying, on the display device, population standard deviation and distance from the mean for brokerages in the investment portfolio over a selectable time period; and determining and displaying, on the display device, population standard deviation and distance from the mean for securities in the investment portfolio over a selectable time period.

It is to be understood that both the foregoing general description and the following detailed description are examples and explanatory and are intended to provide further explanation of embodiments of the invention as claimed.

### BRIEF DESCRIPTION OF THE DRAWINGS

The accompanying drawings, which are included to provide a further understanding of the invention and are incorporated in and constitute a part of this specification, illustrate implementations of the invention and together with the description serve to explain the principles of the invention.

FIG. 1 is a screen shot view of an example home page of a website according to an example embodiment of the present invention.

FIG. 2 is a screen shot view of an example trade errors page of a website according to an example embodiment of the present invention.

FIG. 3 is a screen shot view of an example cross trades page of a website according to an example embodiment of the present invention.

FIG. 4 is a screen shot view of an example volume page of a website according to an example embodiment of the present invention.

FIG. 5 is a screen shot view of an example currency/commissions page of a website according to an example embodiment of the present invention.

FIG. 6 is a screen shot view of an example commissions by day page of a website according to an example embodiment of the present invention.

FIG. 7 is a screen shot view of an example currency breakdown and transaction summary page of a website according to an example embodiment of the present invention.

FIG. 8 is a screen shot view of an example accounts overview page of a website according to an example embodiment of the present invention.

FIG. 9 is a screen shot view of an example best buys page of a website according to an example embodiment of the present invention.

FIG. 10 is a screen shot view of an example review page of a website according to an example embodiment of the present invention.

FIG. 11 is a screen shot view of an example summary page of a website according to an example embodiment of the present invention.

FIG. 12 is a screen shot view of an example account combinations page of a website according to an example embodiment of the present invention.

FIG. 13 is a screen shot view of an example account transactions page of a website according to an example embodiment of the present invention.

FIG. 14 is a screen shot view of an example account sequencing page of a website according to an example embodiment of the present invention.

FIG. 15 is a screen shot view of an example mean pricing study page of a website according to an example embodiment of the present invention.

FIG. 16 is a screen shot view of an example questionnaire page of a website according to an example embodiment of the present invention.

FIG. 17 is a screen shot view of an example risk analysis page of a website according to an example embodiment of the present invention.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DESCRIPTION OF EMBODIMENTS

Reference will now be made in detail to embodiments of the present invention, examples of which are illustrated in the accompanying drawings. In the following description, when a detailed description of well-known functions or configurations related to this document is determined to unnecessarily cloud a gist of the invention, the detailed description thereof will be omitted. The progression of processing steps and/or operations described is an example; however, the sequence of steps and/or operations is not limited to that set forth herein and may be changed as is known in the art, with the exception of steps and/or operations necessarily occurring in a certain order. Like reference numerals designate like elements throughout. Names of the respective elements used in the following explanations are selected only for convenience of writing the specification and may be thus different from those used in actual products.

It also may be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It also may be understood that the term “and/or” as used herein refers to and encompasses any and all possible combinations of one or more of the associated listed items. It may be further understood that the terms “includes,” “including,” “comprises,” “has,” “have,” “having,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

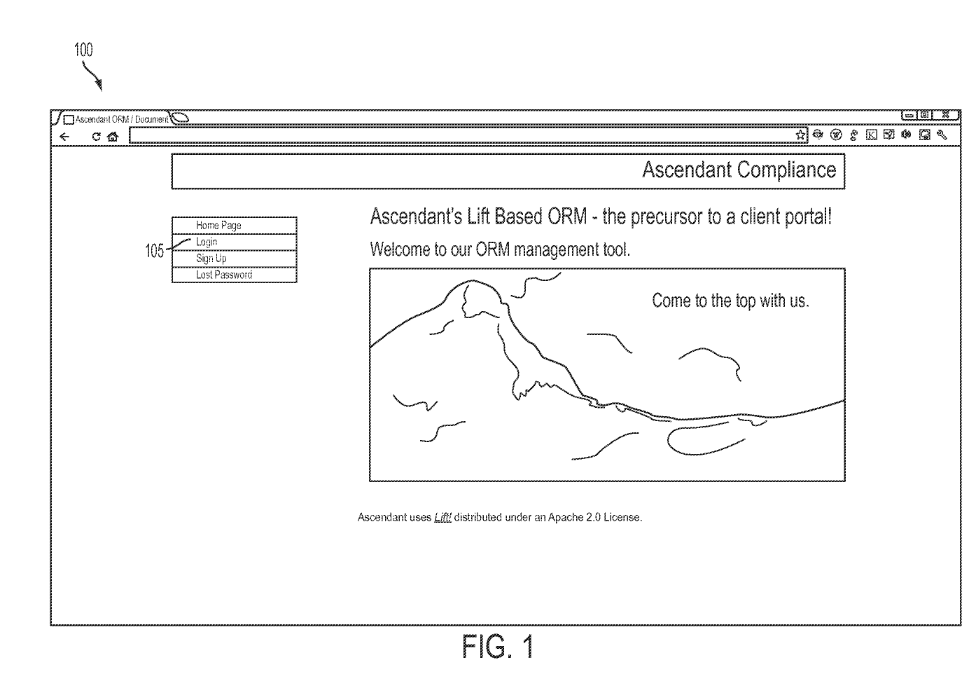

FIGS. 1-17 are example screen shots of a Compliance Manager for trade blotter analysis in accordance with embodiments. Embodiments may include a Compliance Manager, which may be a heuristic database of proprietary and other documents and an extensive library of regulatory documents with customizable tagging and search functionality. The proprietary documents may include, for example, templates, including unique and/or customizable templates. FIG. 1 is an example of a home page for a web-based application including the Compliance Manager. All screen shots may be displayed on a display device.

Trade Blotter Manager

FIGS. 1-15 are screen shots of example embodiments of a Trade Blotter Manager.

With reference to FIGS. 1-10, embodiments may provide a software tool that examines the trade blotter of Investment Advisers and Broker Dealers. Embodiments may provide a highly secure Platform (e.g., Lift™, an open-source web framework; others will be known to those skilled in the art). The Trade Blotter Manager is one component or module of the Platform that also may provide access to a substantial, multi-faceted user interface that may serve as a gateway to various compliance functions (the Compliance Manager). The Platform may be designed to implement real-time collaboration. Collaborative processes may permit users, such as investment advisers and broker dealers, to access workflow simultaneously for research, for compliance surveillance, to manage policies and procedures management, and for training purposes. Additional or multiple users may simultaneously work together on the Trade Blotter Manager or in other modules of the Compliance Manager. The Trade Blotter Manager (“Manager”) may be one module of the Compliance Manager.

The Trade Blotter Manager, one component of the Compliance Manager, may utilize data imported from an Microsoft Excel® spreadsheet that has been provided by a client or investment adviser, which may include all the trading activity of the client or adviser for a specified period of time, usually quarterly, but ranging from weekly, to monthly, quarterly, and annual periods. Any time period may be specified in embodiments. Some of the functionality of the Trade Blotter Manager is listed in summary below:

The Trade Blotter Manager may examine specific trade data in the defined period and may identify potential transaction errors and/or anomalies in the data set. Through the use of proprietary algorithms based upon standard deviation studies, the Trade Blotter Manager also may find certain patterns of transactions, such as one or more accounts, brokers, or brokerage firms receiving favorable or less favorable treatment in the form of best pricing when buying or selling securities;

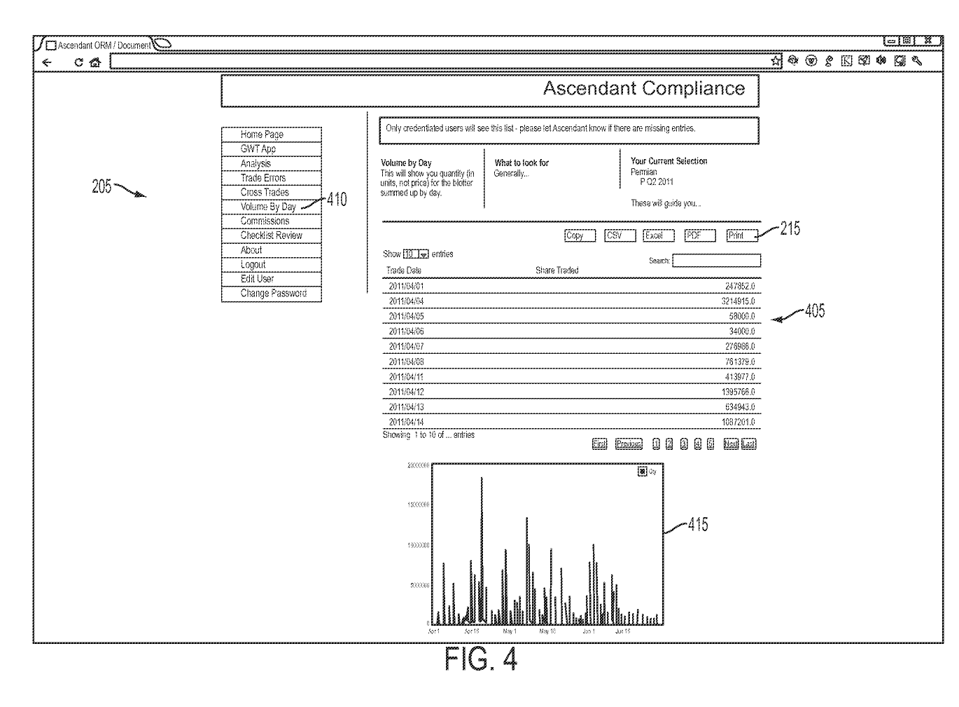

The Trade Blotter Manager also may examine and provide a graphic summary of trading volume by day as derived from a firm's trade blotter. This tool may identify volume patterns, which may be displayed on a daily bar chart (or other display known to those of skill in the art) and may reveal end of the month mark-ups in held securities or end of the quarter window dressing. See FIG. 4 reference 405, 415. “Window dressing” generally is a manipulative and misleading strategy used to make a fund appear more attractive, used by portfolio managers near year end or quarter end to improve the appearance of the portfolio/fund performance before presenting it to clients or shareholders. Often, for example, the fund manager may sell stocks with large losses.

The tool may examine volume spikes or periods of heavy or unusual activity, which may raise questions with regards to trading practices and style drift.

Brokerage commission activity may be examined and summarized in a series of particular graphic representations. These graphics describe daily commission volume and percentage of total commission by brokerage firm and representatives who executed the trade orders from the investment manager. Such studies may reveal undesirable patterns in brokerage firm or representative use, raise questions regarding inappropriate soft-dollar business, and point to issues surrounding best execution.

The Trade Blotter Manager may use historical and live data feeds for further analysis of individual companies by examining the news and corporate activity that occurred during the defined period. This tool can identify transactions that occur in relative proximity to such news or corporate events that may reveal previous knowledge or understanding of those events or Insider Trading activity.

Historical and live data feeds also may be used to verify and obtain accurate pricing of securities, especially in the case of debt-securities and obtaining an understanding of the day's price trading range for the purpose of analyzing the quality of price executions against the volume weighted average price (VWAP) for a given trading session.

Historical and live data feeds also may be used in the analysis of market-based or news events with respect to overall market volume patterns in order to compare and analyze volume patterns discovered within a given trade blotter which may give rise to compliance violations.

The user of the Trade Blotter Manager can “tag” or select transactions or views, add comments to selected data, and build a custom report or documentation of their review process. The tagging of individual transactions or other data may assist in the construction of a log or report for later compliance review to identify breaches or violations of SEC rules.

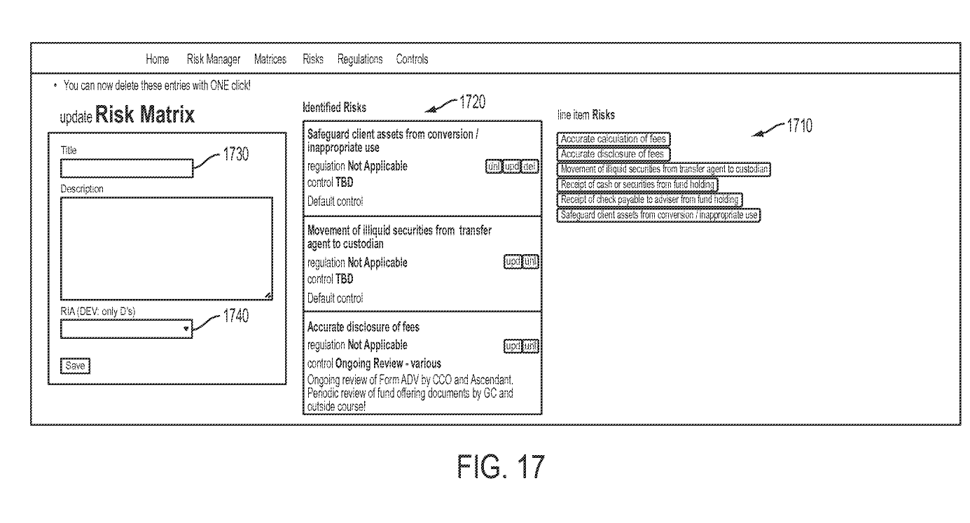

In addition, a fully automated, consolidated report, which may encompass all analyses and may provide a “risk ranking” based on proprietary criteria, can be printed or exported as a portable document file (PDF) for further analysis or demonstration of surveillance process (Trade Blotter Risk Assessment) (see FIG. 17 and the description below of a Risk Manager).

A user or investment adviser can determine who may gain access to the Trade Blotter Manager and reports and may access collaborative workflow. The tool may allow for multiple users (for example, the Chief Compliance Office (CCO), Risk Officer, Head Trader) who have logins that would permit review of queries, and e-mail communication regarding specific queries or reports. Users also can access collaborative views for training and conferring on data and information.

Reporting and documentation, whether accomplished through the “tagging” and logging process, the automated, consolidated process, or through collaborative workflow, can be archived for recordkeeping and future reference.

The Trade Blotter Manager may be an SAAS (software as a service) analysis tool delivered through, e.g., a combination of GWT™ (Google™ Web Toolkit) and Lift™ (secure web framework). The engine for this platform may be, for example, a Postgres™ (PostgresSQL™) relational data model. All specifically-mentioned applications, software, and programs are intended only as examples. Embodiments include other applications, software, and programs, as well as non-transitory computer-readable media including applications, software, and programs.

The Platform should be secure. The example of a Lift™ platform may be considered highly secure. The programming language for Lift™ is Scala, which is a hybrid, functional/object-oriented language built on top of Java.

An example process of embodiments of the Trade Blotter Manager can be described in the following operations:

1. Take or accept the trade blotter from clients in Microsoft Excel® format;

2. Load the data and normalize in the relational database, Postgres™;

3. Run summary statistics on the normalized data which involves creating additional data in a combination of Java and PlpSQL functions;

4. Render views through the Lift™ and GWT™ portal.

Embodiments may examine prices in similar transactions, calculate the mean price, and examine distances from that mean. The user of the Trade Blotter Manager can bore down into individual accounts and transactions that may occur at certain or abnormal distances from the mean calculation on a regular basis.

In some embodiments, the client, adviser, or user may provide a transaction blotter with the following information:

a. Account Number

b. Account Name

c. Trade Date

d. Settlement Date

e. Security Symbol

f. Security Description

g. CUSIP/SEDOL (Committee on Uniform Securities Identification Procedures/Stock Exchange Daily Official List)

h. Transaction (Buy, Sell, Sell Short, Cover Short)

i. Price

j. Commission Cost

k. Brokerage Firm

l. Brokerage Representative

m. Strategy (optional)

n. Currency (optional)

Login

Login into the Trade Blotter Manager may take place through the Platform front end 100 of FIG. 1. A login link 105 may be provided. When the user or client accesses the main page, the loaded blotters may be displayed by time period. The user also may view a summary of logins, time spent in the system, and percentage completed in the workflow process of the current blotter.

Views (Query Results from Summary Statistics)

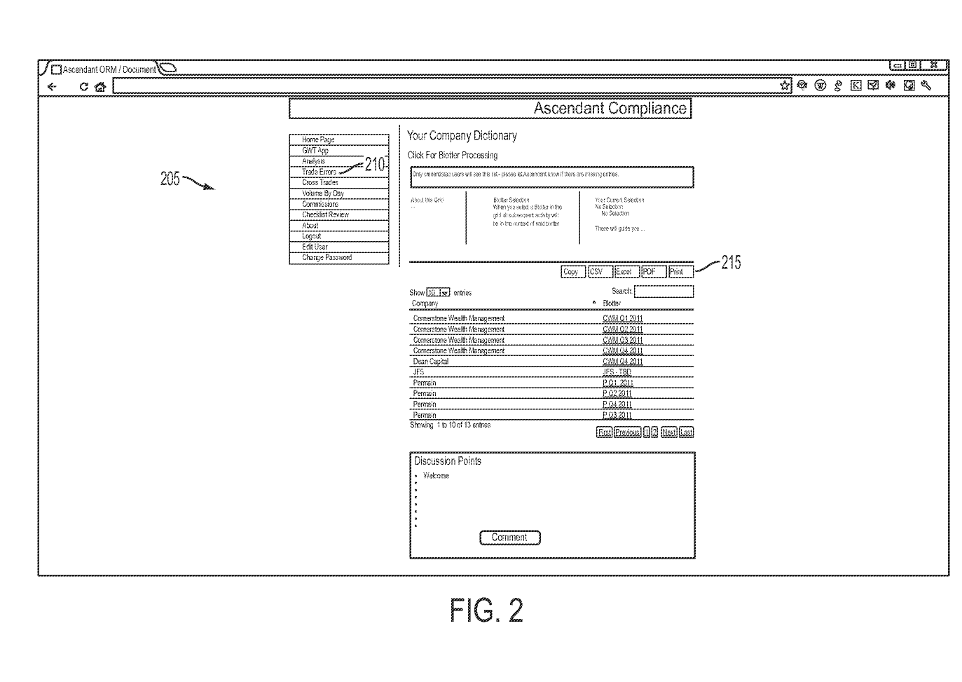

The following selections or views, which represent query results, may be available, e.g., from the left hand menu 205 (FIG. 2) of the Trade Blotter Manager, for example, by clicking a desired link. It should be appreciated that other visual layouts are within the scope of embodiments. Any one or more of the following may be available. The views are discussed in an example order of workflow:

1. Trade Errors/One Day, Two Day, Three Day Same Account/Same or Different Account. This view summarizes potential “same-day” trade errors (buys and sells in the same account in the same security on the same day). This same study may then be expanded by 2-3 days on either side of the transaction (before or after) for the purpose of determining trade errors or frequent trading. The study can be expanded beyond 3 days to capture failed trades and trades that have not settled for longer periods of time. This view may be selected with the Trade Errors option 210 on the left hand menu 205.

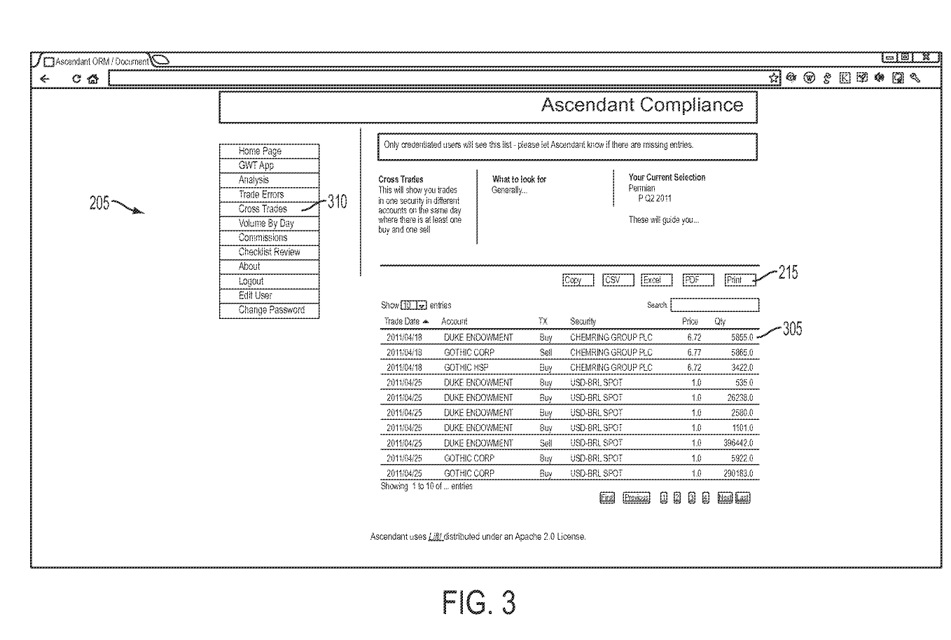

2. Cross or Principal Trades. This view may provide the user with a summary of transactions (FIG. 3, 305) occurring in the same securities, on the same day, in the same amount in different accounts. This may enable the CCO to identify potential securities law violations. This view may be selected with the Cross Trades option 310 on the left hand menu 205.

3. Counter Positions. This view may provide the user with a summary of instances of long and short positions occurring within the same security. This view may provide information on potential opposing positions and may raise questions of conflicts in strategy on the part of an adviser. This may be an option selectable, for example, from the Cross Trades view of FIG. 3.

4. Volume. This view may provide the user with a graphic display of the overall trading volume, per day, in the given period, which may be presented in a bar chart (415). This study of individual session volume may map back to specific transactions, trades, or time periods which should be examined in greater depth (405). This view may be selected with the Volume option 410 on the left hand menu 205.

5. Gross Per Brokerage Firm. A pie chart summary across the blotter of the total price times quantity of transactions for specific broker dealers may be provided. The aggregate dollar amounts may reflect a pattern of payouts to specific broker dealers. This study also may provide a means of examining brokerage activity for fixed income transactions in which commissions may not be quantified on the trade blotter. This may be an option selectable, for example, from the Volume view of FIG. 4.

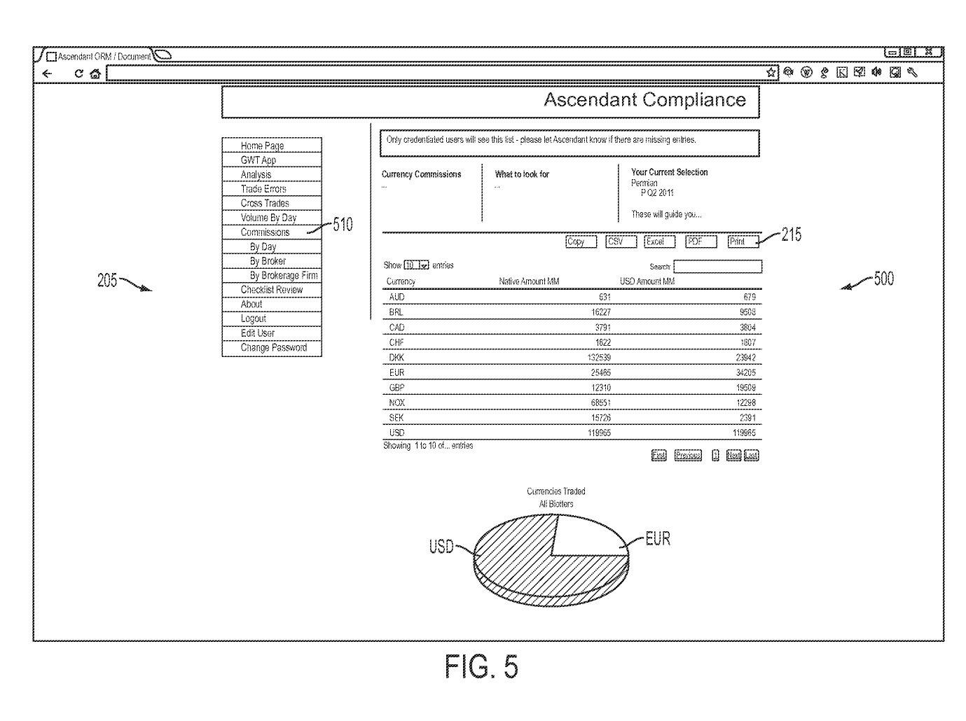

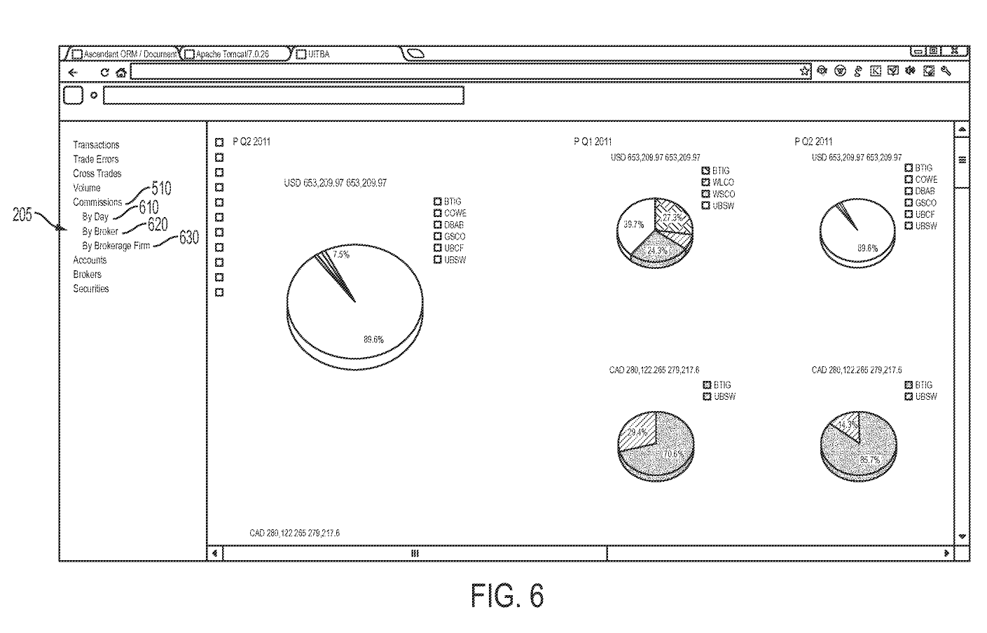

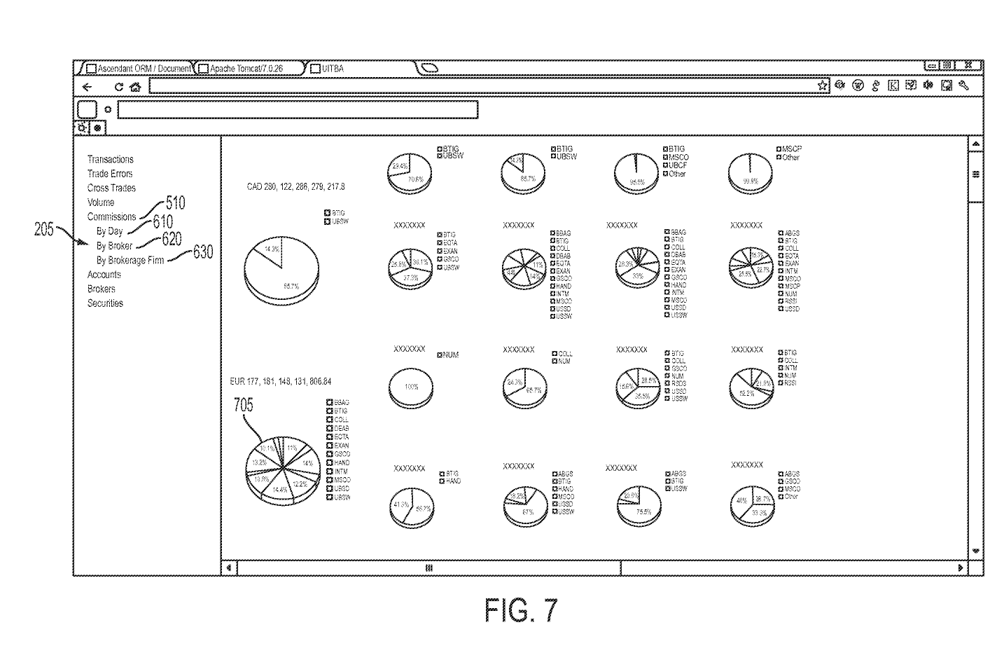

6. Commissions By Day/By Broker/By Brokerage Firm. FIG. 5 shows a view 500 of a volume of commissions presented by currency. This view may be accessed with the Commissions option 510 on the left hand menu 205. FIG. 6 shows options 610, 620, 630, selectable from the initial view 500 from the left hand menu 205. In the FIG. 6 example, Commission By Day (610) is selected, which may be the dollar volume of commissions presented on a daily bar chart for the period examined. Commissions By Broker (620) may be a pie chart of the percentage of commission business conducted by each Brokerage Representative listed in the blotter for the period examined. Commission by Brokerage Firm (630) may be a pie chart of the percentage of commission business conducted by each Brokerage Firm listed on the blotter for the period examined. Commission analysis can reveal inconsistencies in pricing or higher than normal charges. If particular brokerage firms or representatives are heavily favored on a percentage basis, advisers should be able to justify such treatment from a “best execution” standpoint. Patterns of increased commission during certain quarters may suggest poorly managed soft dollar arrangements. FIG. 7 gives examples of more detailed information than the FIG. 6 view with pie charts of transaction summaries (705).

Volume and Commission charts may be displayed horizontally by Quarter, for example, as shown in FIG. 6. In other words, each Quarter may be viewed in relation to previous or following Quarters or views for comparison purposes. In some embodiments, commission amounts and percentages may be broken down by currency, as shown, e.g., in FIG. 7. An amount and percentage of commission conducted by Representatives or Brokerage Firms may be analyzed across currencies for the examined period.

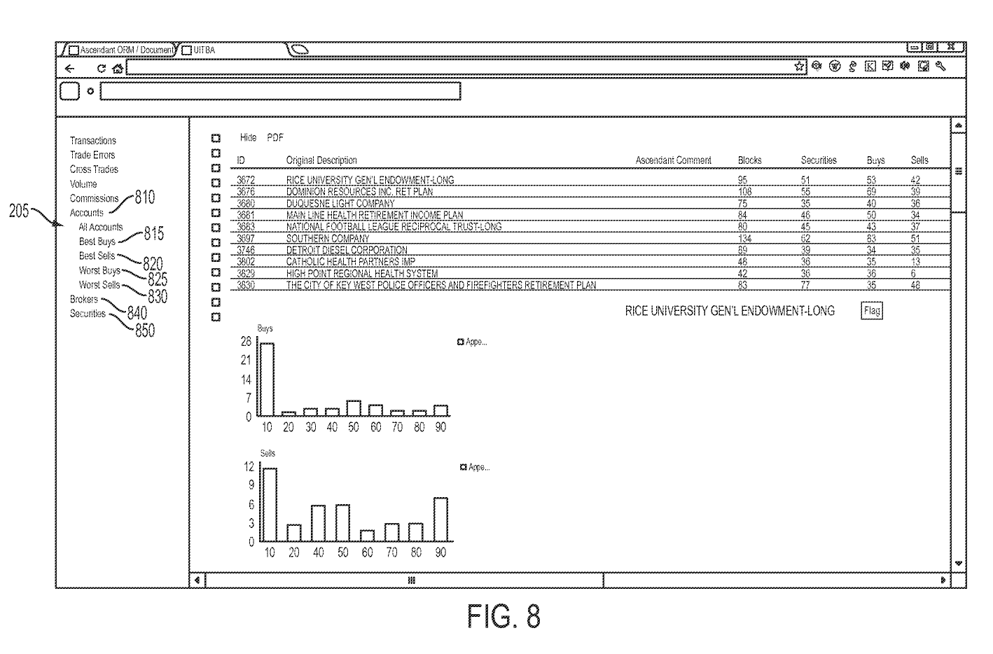

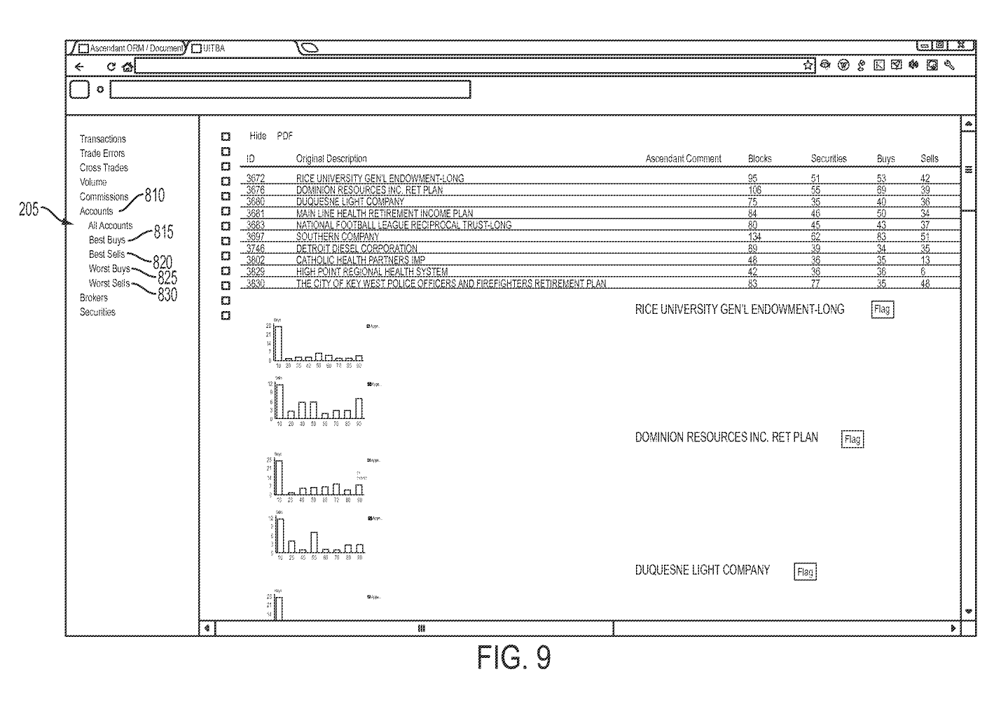

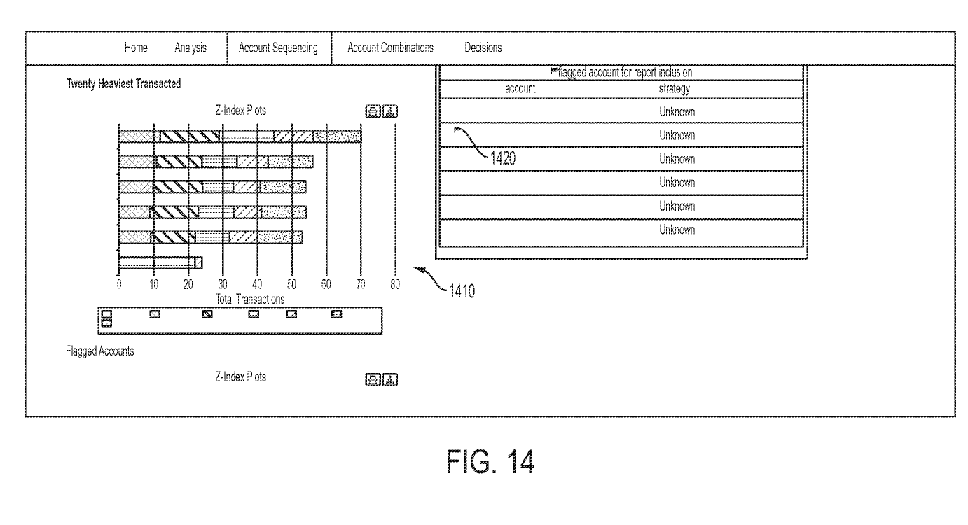

7. Accounts & Sequencing. These are the “sequencing studies” that may permit a user of the Trade Blotter Manager to examine accounts for potential favorable (815, 820) or unfavorable (825, 830) pricing with respect to the calculated mean of a given security. In order to calibrate accounts receiving favorable or unfavorable treatment, herein defined as consistently receiving a price better or inferior to peers based on a like transaction, a certain (variable) time frame and in the same security, population standard deviation (S) may be calculated and then distance from the mean for transactions in an account (the Z-index) may be determined. Then, such Z-indexes may be aggregated to provide a summary overview for a given blotter determining which accounts received more “outlier” events than their peers. The current (variable) time frames for examining transactions may be 0 days (same-day), 3, 7, and 14 day periods. FIG. 8 shows an example view when the Accounts link (810) is selected. FIG. 9 shows an example view when the Best Buys link (815) is selected. These views may be accessed with the Accounts option 810 on the left hand menu 205. FIG. 14 gives additional examples of the Z-indexes.

8. Brokerage Firms & Sequencing. These particular Broker studies represent the “sequencing” views for “Accounts” as described above; however, standard deviation calculations may be summarized by Brokerage Firm, permitting the user/client to view brokerage firms with regards to price transactions relative to peers. Such information may describe whether or not a specific Brokerage Firm is consistently obtaining best or worst pricing based upon standard deviation studies. These views may be accessed with the Brokers option 840 on the left hand menu 205 in FIG. 8. The view may provide expanded menu options, similar to the links 815, 820, 825, 830 under the Accounts link 810.

9. Securities & Sequencing. This particular study provides a summary of all transactions sortable by standard deviation, similar to both Account and Brokerage Firms views. The user can view, at the security level, those transactions that occurred with the greatest range of volatility or highest pricing disparities. This study may point the user to news-related events or “triggers” for increased volatility. These views may be accessed with the Securities option 850 on the left hand menu 205 in FIG. 8. The view may provide expanded menu options, similar to the links 815, 820, 825, 830 under the Accounts link 810.

Other Studies

10. Date Drill Down. This study permits the user/client to view a specific date or time period from the blotter. Examination of Volume studies may suggest taking a closer look or boring down to a specific date for activity, which can be accomplished through the view.

11. Odd Lots. Allows the user to view odd-lot transactions or potential anomalies related to volume or lot size of a transaction. Odd lots may reveal patterns of transaction which require further review.

12. Securities, Accounts, Brokerage Firms. Permits the user to view and search these individual elements. For example, a link may be provided to a database of regulatory documents or other publicly-available information.

Historical and Live Integration

13. Insider Trading. This view provides corporate news and events in the period examined for those securities in the blotter that conform to high level standard deviation thresholds. In other words, high volatility and standard deviation in a specific security may trigger a historical search related to causal information.

14. Mark ups and Mark downs/Best pricing. Based on VWAP (volume weighted average price) for specific debt securities in a given blotter, this view provides a ranking for the execution of such transactions.

15. Market Events. This view lists high volatility or volume sessions for the overall stock market and corresponding news events. Such sessions can then be compared to high volume sessions in the Volume Report (#4 above).

Reporting

System reporting may be designed with the notion of flexibility and geared to the goal of providing compliance personnel with evidence of the forensic testing process. The SEC has identified the concept of documented “proof of process” with regards to compliance procedures as being important.

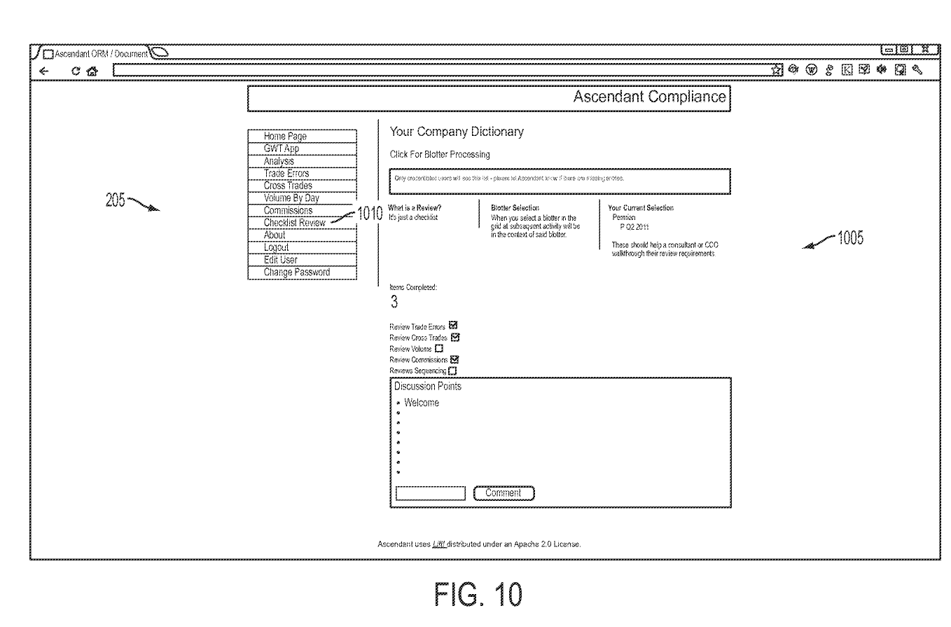

As mentioned in the above description, when a user or client works through the views and menus above, certain transactions, securities and/or accounts can be selected (tagged) and commented upon for aggregation in a log. This log can be kept as a “workflow” document and referenced later in the process, referred to other users for review, and eventually serve as the basis for a report. The log may be a Checklist view 1005 of FIG. 10, which may be accessed with the Checklist option 1010 on the left hand menu 205.

Users also may have the option of printing an automated/consolidated report of all findings and graphics, which may be accompanied by a risk ranking based upon a weighted summation of findings. This consolidated report can be included in specific compliance reporting for a given period, such as a Risk Management Committee's notes for a Quarter.

Users may have the option of printing, exporting to portable document file (PDF), and exporting to Microsoft Excel® various views for analysis and reporting. The print function may be accessed, for example, by a link 215 on any of the FIG. 2-5 views.

Big Data Analysis

Embodiments may provide large database analysis. Over time and as additional blotters are loaded and the data set gets larger, summary statistics may become more meaningful. CCOs and compliance personnel can also test changes and improvements in the trading and management processes.

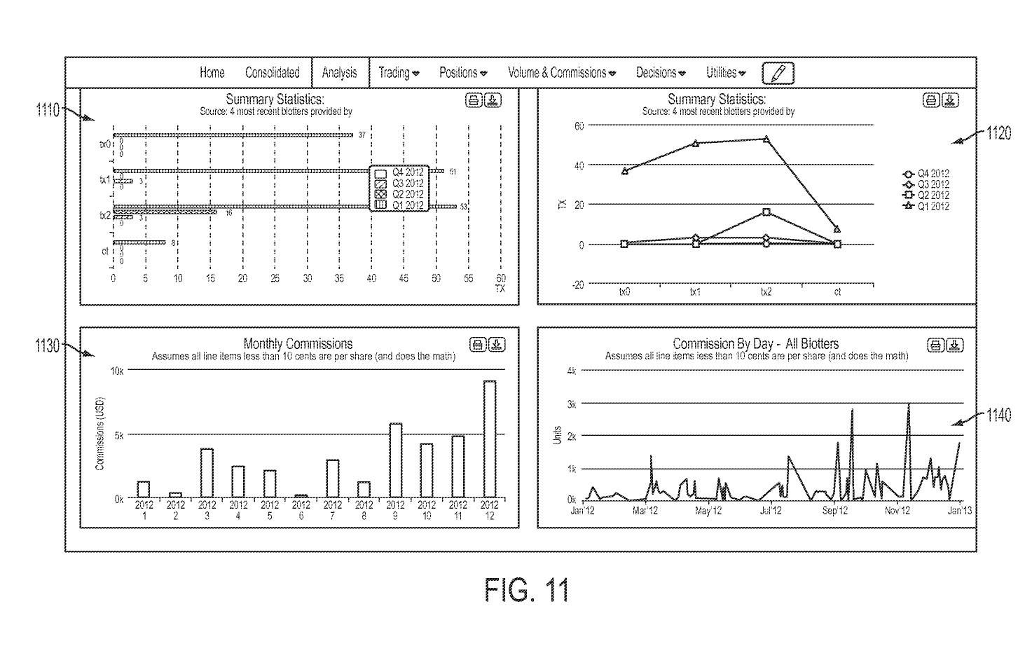

With reference to FIGS. 11-15, the Trade Blotter Manager may include the following components.

1. Summary Statistics and Graphics

The Summary Statistics page (FIG. 11) may provide data and various graphics concerning the following example elements:

a.) Short-term trading in a “0” or same-day to 5-day window;

b.) Monthly (1130) and Daily (1140) views of Commissions across all blotters; and

c.) Transaction totals (1110), short-term trading across measured time frames (which may be adjusted) (1120), and cross trades.

The FIG. 11 example may be customized or may use other graphics from within Trade Blotter Manager Views (as described in the FIG. 1-10 examples) can be brought forward to this Summary page.

2. Account Combinations

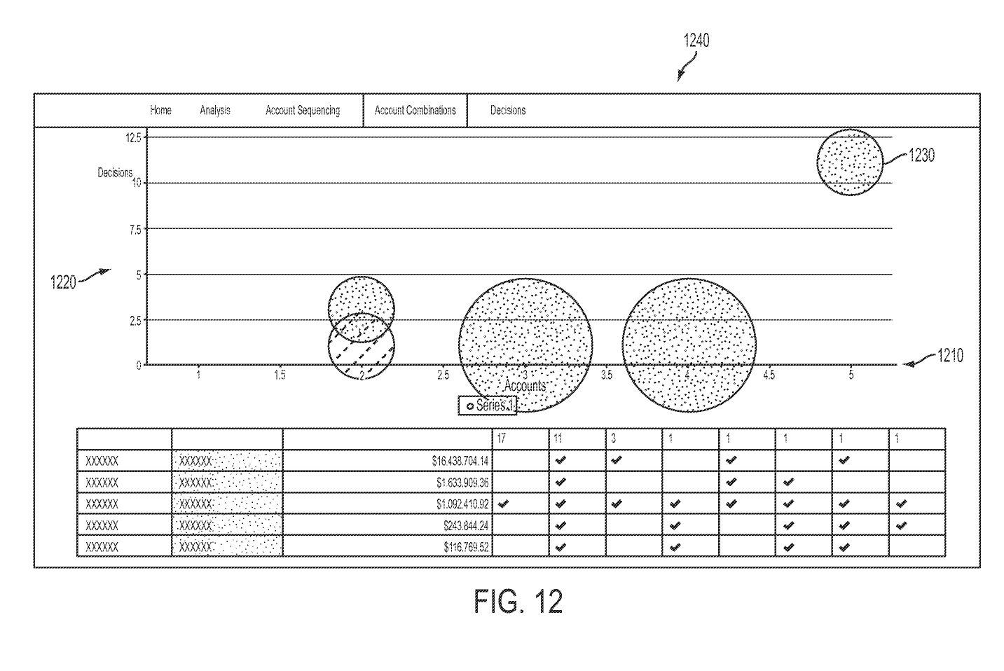

FIG. 12 describes an example account activity of an investment adviser or broker dealer with a display according to an embodiment.

a.) The X-axis (1210) may describe the number of accounts grouped together in a specific number of transactions.

b.) The Y-axis (1220) may describe the number of transaction decisions.

In the FIG. 12 example, the balloon 1230 may indicate that five accounts are transacting roughly eleven times together. A user may then use the Trade Blotter Manager to retrieve additional detail into those accounts to verify that they should be trading together, e.g., with the FIG. 2-10 options. Similarly, a user may use the Trade Blotter Manager to retrieve additional detail into the other individual account to examine their characteristics of inclusion exclusion, e.g., with the FIG. 2-10 options. FIG. 12 may provide a snapshot 1240 of how many accounts are transacting together and with what number of transactions during the period examined.

3. Account Transactions

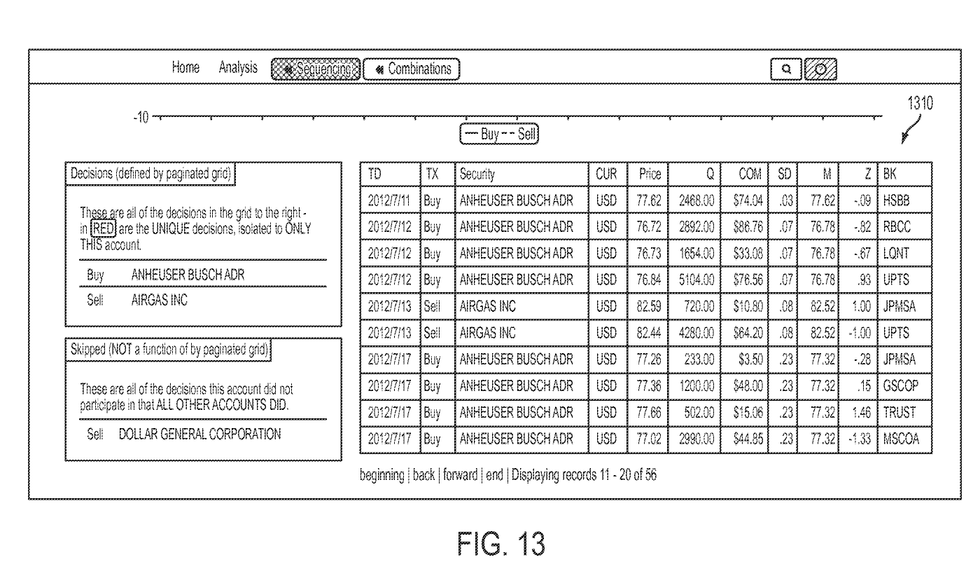

With reference to FIG. 13, the screen shot depicts an example grid 1310 which describes “all transactions which a specific account did not participate in.” The adviser may support fairness in the process of allocating positions to accounts and be able to justify reasons for participation or lack thereof in specific transactions. FIG. 12 may represent a further detail of transactions and participation.

4. Accounts Sequencing

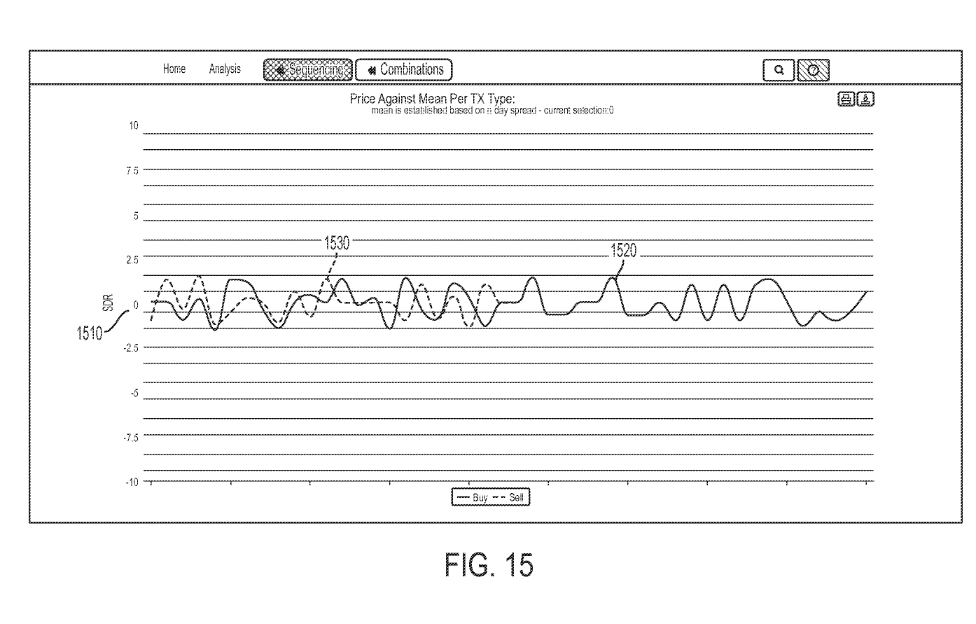

FIG. 14 is an example screen shot of a high-level account page for Sequencing Studies lists accounts by heaviest transacted, using Z-index plots 1410. These may be the Z-indexes discussed above with reference to FIG. 8. These accounts can be viewed in further detail and may be examined based upon all transactions calculated against a mean (average) price for those transactions (see FIG. 15). This summary page also may list accounts that have been flagged (1420) based upon the number of transactions occurring away from mean pricing, which may indicate favored or disfavored accounts from an allocation standpoint. The same Z-indexes may be applied by brokerage firm or individual securities discussed above.

5. Account Sequencing, Mean Pricing Studies

FIG. 15 is an example screen shot showing transactions which have occurred at specific prices surrounding a calculated mean, which is depicted by the “0” line 1510. In this example the first line 1510 signifies purchases (buy prices), and the second line 1520 signifies sales (sale prices). FIG. 15 may provide a snapshot of buy and sell activity and a quick view of how many buys are occurring above or below the mean, which may mean worse or better buy prices. This may be conversely true for sells occurring during the examined period. FIG. 15 may have scroll capability in which the mouse cursor can be placed on the buy and sell lines 1510, 1520 and individual transactions may be displayed. A user may identify accounts that are consistently favored or disfavored.

Risk Manager

The FIG. 1 example login 105 may provide access to a Risk Manager. Embodiments may provide a web-based application which may examine disclosures, surveys, and assorted materials of SEC-registered Investment Advisers and may assign a proprietary risk rating. “Investment Adviser” is a broad term which includes, for example, investment managers of various types, including traditional investment managers and hedge and private fund managers. The risk rating may be based upon a proprietary algorithm which may read specific values assigned to Form ADV question responses, responses to targeted questionnaires, and components of an investment adviser's compliance documentation. In addition to the proprietary risk rating, which may help predict the frequency of potential exams and risk ratings of SEC, the following outputs also may be generated in the analysis, as shown in FIG. 17:

1. Produce an automated Risk Inventory 1710, the maintenance of which is expected by the SEC in its examination program and is a standard component of a document request list (The SEC issues a document request list prior to the examination of an investment adviser);

2. Identify or flag potential errors in responses to Form ADV, questionnaires, or materials based upon statistical-anomaly analysis of benchmarked data;

3. Enable risk identification 1720 which can be utilized with Compliance and Senior Management, as well as regulators.

The Risk Manager may be built upon the above-described customized Platform (e.g., Lift™) (see FIGS. 1-15). The Risk Manager may be one component or module of the Platform which will also provide access to a substantial, multi-faceted user interface which may serve as a gateway to various compliance functions (e.g., the Compliance Manager discussed supra). As mentioned above, the Trade Blotter Manager also may be a component of the Compliance Manager. The Compliance Manager may include a database of proprietary documents and an extensive library of regulatory documents with customizable tagging and search functionality. The Platform may be designed to implement real-time collaboration. Collaborative processes may permit users and other investment advisers and broker dealers to access workflow simultaneously for research, for compliance surveillance, to manage policies and procedures, and for training purposes. Additional or multiple client users may simultaneously work together on the Risk Manager or in other modules of the Compliance Manager.

Mapping

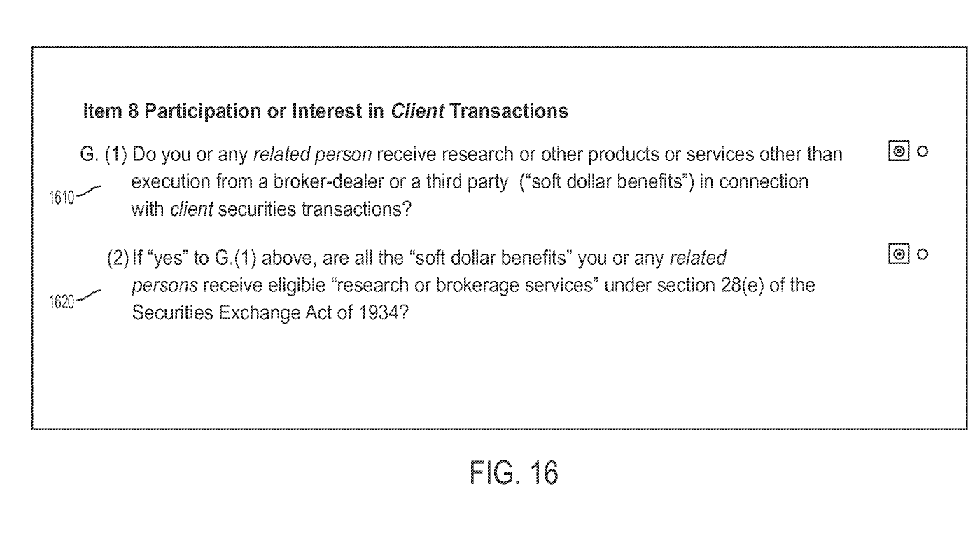

The Risk Manager may be designed to be a central component of the Compliance Manager, which can be expanded upon the inclusion of additional client documents. An investment adviser or broker dealer's compliance program may be built upon several key documents which can then be mapped to the Risk Manager. The Compliance Manual may contain the policies and procedures to be followed by a firm in order to address specific rules, regulations, and expectations of the SEC. The Risk Manager, after scanning disclosure documents, questionnaires, and other materials, may map identified risks or flagged potential errors to corresponding sections of the Manual. For example, if the Risk Manager flags the response to the FIG. 16 (“Item 8 in FORM ADV Part I”), regarding soft dollar transactions in the first question 1610, as an increased risk factor, the Client can be alerted to refer to the “Trading Practices” section of the Compliance Manual for inclusion or review of appropriate policies and procedures. “Soft dollar benefits” in the second question 1620 refers to services received by an investment adviser for writing specific amounts of commission dollars, an “arrangement,” with a broker dealer.

In further extending this example to other components of the Compliance Manager, the Risk Manager additionally may be mapped to the corresponding query and view in the Trade Blotter Manager, which may examine characteristics of the adviser's trade blotter activity. In other words, the amount of commission dollars expressed as a percentage may be examined and presented in graphic format to manifest the measured commission activity of all brokers. This activity may be examined by the investment adviser to determine the relationship between high risk disclosures and actual practices.

Such cross reference and mapping to additional documents can include an investment adviser's Compliance Manual, Code of Ethics, SEC Deficiency Letters. Deficiency letters are an output from the SEC examination process, findings of deficiencies in an adviser's compliance program, pre-existing risk matrices, and other relevant documents.

Marketplace

The target market for the Risk Manager further may be defined to include SEC advisers with greater than $100 million in assets under management, advisers or sub-advisers to investment companies, pension consultants, related advisers, and multi-state advisers. These categories may include registered entities with the SEC whose disclosure information is publicly available through the Investment Adviser Public Disclosure (IAPD) system.

Embodiments of the Risk Manager may assist investment advisers with the risk assessment process, gaining an understanding of the firm's risk relative to peers, the likelihood of being examined by the SEC, the improvement of internal process, and, ultimately, the reduction of firm risk to acceptable levels. The Risk Manager may provide Chief Compliance Officers and Management objective, independent, and automated process for assessing and reducing risk.

Approach

Embodiments may include processing and organizing Form ADV Data, the disclosure information for an investment adviser, from the SEC's Investment Adviser Public Disclosure (IAPD) database. The processed and organized information is shown, for example, in FIG. 17. The database is currently free and available 24 hours per day. As investment advisers make changes, additions, or revisions to their disclosure documents, they are posted to the IAPD which may impact (1) the proprietary risk rating, (2) the results of the generated risk matrix, and (3) detailed mappings to additional compliance-related documents.

Sample and initial items for Form ADV analysis may include, but are not limited to:

1. Key firm identification characteristics from Form ADV Item 1 such as;

2. Regulatory Assets Under Management;

3. Whether or not the firm has more than 1 billion in assets (dollars, pounds, euros, etc.) under management;

4. Whether or not the firm participated in performance-based fees;

5. Whether or not the firm sponsors any wrap-fee programs;

6. Whether or not the firm has Custody of client funds; and

7. Whether or not the firm has disclosed disciplinary events.

FIG. 16 is an example of questions to be presented to a user in a questionnaire. Embodiments may include an additional Initial Questionnaire displayed to the user in order to assist in Risk Manager calculations. The Initial Questionnaire contains several queries which, based upon industry experience and a direct understanding of SEC priorities, may be important in determining an investment adviser's risk profile. Sample and initial risk profile questions and requests may include, but are not limited to:

1. Do you have any affiliated broker/dealers or other businesses?;

2. Do you transact in structured products or complex investment vehicles?;

3. Please provide the date of SEC exams during the past 10 years and corresponding deficiencies noted;

4. Have you recently or do you intend in the future to change your Accounting Firm?;

5. Have your recently or do you intend in the future to change your CCO or other key personnel?;

6. Have your recently or do you intend to change business lines, core strategies or client services?; and

7. Have you recently had any security breaches or incidents related to loss of data?

Finally, and as users add components and additional compliance-related documents to the Compliance Manager database, the Risk Manager may scan such documents (e.g., Compliance Manual and Code of Ethics) for completeness, mapping to other scanned and questionnaire results for further refining an adviser's proprietary risk rating as shown in FIG. 17.

All disclosure, questionnaires, and client documents mentioned above may be stored, e.g., in a PostgresSQL relational database with strict security requirements and customized encryption capabilities.

Timing of Analysis

As the IAPD database is updated, when registered investment advisers amend as necessary and file annual updating amendments, Risk Manager results, outputs, and mappings may change accordingly. Changes in results and outputs also may occur based upon updated questionnaire responses and compliance program documents. Risk Manager results may be recalculated every six months; however, CCOs may wish to update text/commentary and risk matrix items on a quarterly basis for review by appropriate executive and risk committees. Other time periods are also included in embodiments.

System Access and Interactivity

Users may have access to Risk Manager reporting views through the secure Platform (e.g., Lift™) login. Similar to other Compliance Manager components, the user may log in to the system, and may record notes/text along-side of views, which can then be included in consolidated reporting. In addition, users may add items to the automated risk matrix, and, as compliance documents are added to the Compliance Manager, it may be possible to make additions and revisions to those documents (e.g., Compliance Manual), directly through the mapped interface of the Risk Manager. In other words, flagged items for increased risk or potential errors can be addressed immediately through the relational-mapped database to corresponding documents.

Reporting

Outputs from the Risk Manager may include a consolidated report including, for example, (1) the determined Risk Rating, (2) a list of ADV and questionnaire responses flagged as contributing to increased risk, (3) a list of potential errors and omissions in disclosures and compliance-related documents, (4) documentation for the firm's Annual Review documentation, and (5) a risk matrix generated from scanned results with enhanced language pertinent to findings. Reporting may take place in the form of an encrypted PDF which can be generated by a user.

Summary

The Risk Manager may be a web application that allows a user (including, e.g., a manager or a client) to manage a database of user disclosure information, questionnaire responses, and standard compliance-related documents to assist users in understanding and aggregating risk factors, which can be expressed in a rating and risk inventory document. Although a web application is discussed, one skilled in the art should understand that other applications and programs, including non-transitory computer-readable media having applications and programs, are included in the scope of embodiments.

Identified risks can be cross-referenced to other forensic components of the Risk Manager such as the Trade Blotter Manager.

Workflow related to addressing identified risk factors can be mapped to both compliance documents and to pending components such as a Calendar Manager (see, e.g., FIG. 4), which may allow users to track workflow on an objectives-based timeline factoring in regulatory deadlines.

The Risk Manager may serve as the central nerve system of the Compliance Manager, assisting clients with the assessment of included documentation and components and aiding clients in the ultimate goal of improving their risk profile.

The workflow which results from the Risk Manager process may serve as a “best practice” evidence of a registered investment adviser's continuous monitoring of risk factors.

With reference to the FIG. 17 example:

1. The left hand column 1730 includes the name of the adviser, and the bottom drop-down menu 1740 corresponds to registered investment advisers (RIAs) listed in the IAPD database;

2. The middle column 1720 displays flagged risks based upon Risk Manager scanning of Form ADV and questionnaire analysis; and

3. The right hand column 1710 represents the initial risk matrix line items.

The processes, functions, methods and/or software described herein may be recorded, stored, or fixed in one or more computer-readable storage media that includes program instructions to be implemented by a computer to cause a processor to execute or perform the program instructions. The media also may include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the devices described herein may be incorporated in or used in conjunction with mobile devices such as a cellular phone, a personal digital assistant (PDA), a digital camera, a portable game console, and an MP3 player, a portable/personal multimedia player (PMP), a handheld e-book, a portable tablet and/or laptop computer (e.g. personal computer (PC)), a global positioning system (GPS) navigation, and devices such as a desktop computer (e.g. PC), a high definition television (HDTV), an optical disc player, a setup and/or set top box, and the like, consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or may be processed by the microprocessor and N may be 1 or an integer greater than 1. Where the computing system or computer is a mobile apparatus, a battery may be additionally provided to supply operation voltage of the computing system or computer.

It may be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

All trademarks used herein are the property of their respective owners.

A number of examples have been described above. Nevertheless, it may be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the claims.

What is claimed is:

1. A regulatory compliance management system, comprising:
a user data entry device;
a display device;
a processor comprising logic to process data;
a database in communication with the processor, the database comprising regulatory and other documents;
a query module in communication with the processor and the database, the query module configured to tag and search the documents based on an investment portfolio;
an analysis module in communication with the processor and the query module, the analysis module configured to receive the documents from the query module and, based on the received documents:
determine and display, on the display device, trade errors;
summarize and display, on the display device, transactions in different accounts in the investment portfolio;
summarize and display, on the display device, instances of long and short positions occurring within a same security in the investment portfolio;
determine and display, on the display device, daily trading volume for a security in the investment portfolio;
determine and display, on the display device, total price times quantity of transactions for specific broker dealers in the investment portfolio;
determine and display, on the display device, commissions in the investment portfolio;
determine and display, on the display device, population standard deviation and distance from the mean for transactions within accounts in the investment portfolio over a selectable time period;
determine and display, on the display device, population standard deviation and distance from the mean for brokerages in the investment portfolio over a selectable time period; and
determine and display, on the display device, population standard deviation and distance from the mean for securities in the investment portfolio over a selectable time period.

2. The system of claim 1, wherein the analysis module is further configured to, based on the received documents:
determine and display, on the display device, qualitative risk assessments and risk mapping of the individual characteristics of an investment adviser and its regulatory requirements; and
determine and display, on the display device, qualitative assessments of an investment adviser in relation to the universe of SEC registered investment advisers.

3. A method for regulatory compliance management, the method comprising:
based on an investment portfolio, tagging and searching, by a query module, regulatory and other documents, the query module being in communication with a processor and a database comprising the documents;
receiving, by an analysis module in communication with the processor and the query module, the documents from the query module;
based on the received documents:
determining and displaying, on a display device, trade errors;
summarizing and displaying, on the display device, transactions in different accounts in the investment portfolio;
summarizing and displaying, on the display device, instances of long and short positions occurring within a same security in the investment portfolio;
determining and displaying, on the display device, daily trading volume for a security in the investment portfolio;
determining and displaying, on the display device, total price times quantity of transactions for specific broker dealers in the investment portfolio;
determining and displaying, on the display device, commissions in the investment portfolio;
determining and displaying, on the display device, population standard deviation and distance from the mean for transactions within accounts in the investment portfolio over a selectable time period;
determining and displaying, on the display device, population standard deviation and distance from the mean for brokerages in the investment portfolio over a selectable time period; and
determining and displaying, on the display device, population standard deviation and distance from the mean for securities in the investment portfolio over a selectable time period.

4. The method of claim 3, further comprising, based on the received documents:
determining and displaying, on the display device, qualitative risk assessments and risk mapping of the individual characteristics of an investment adviser and its regulatory requirements; and
determining and displaying, on the display device, qualitative assessments of an investment adviser in relation to the universe of SEC registered investment advisers.

5. A non-transitory computer-readable medium including a program and a computer executable program code for a computer-implemented method for regulatory compliance management, comprising:
based on an investment portfolio, tagging and searching, by a query module, regulatory and other documents, the query module being in communication with a processor and a database comprising the documents;
receiving, by an analysis module in communication with the processor and the query module, the documents from the query module;
based on the received documents:
determining and displaying, on a display device, trade errors;
summarizing and displaying, on the display device, transactions in different accounts in the investment portfolio;
summarizing and displaying, on the display device, instances of long and short positions occurring within a same security in the investment portfolio;
determining and displaying, on the display device, daily trading volume for a security in the investment portfolio;
determining and displaying, on the display device, total price times quantity of transactions for specific broker dealers in the investment portfolio;
determining and displaying, on the display device, commissions in the investment portfolio;
determining and displaying, on the display device, population standard deviation and distance from the mean for transactions within accounts in the investment portfolio over a selectable time period;
determining and displaying, on the display device, population standard deviation and distance from the mean for brokerages in the investment portfolio over a selectable time period; and
determining and displaying, on the display device, population standard deviation and distance from the mean for securities in the investment portfolio over a selectable time period.

6. The computer-readable medium of claim 5, further comprising, based on the received documents:
determining and displaying, on the display device, qualitative risk assessments and risk mapping of the individual characteristics of an investment adviser and its regulatory requirements; and
determining and displaying, on the display device, qualitative assessments of an investment adviser in relation to the universe of SEC registered investment advisers.
